(19) United States
(12) Patent Application Publication
(10) Pub. No.: US 2016/0232743 A1
(43) Pub. Date: Aug. 11, 2016

(54) Gaming Machine and Game Having Bonusing Slot Symbols Based on Mapped Locations

(71) Applicant: Gemini Digital Development, Inc., Las Vegas, NV (US)

(72) Inventors: Alfred Thomas, Las Vegas, NV (US); Benjamin T. Gomez, Las Vegas, NV (US); James P. Jackson, Las Vegas, NV (US)

(21) Appl. No.: 14/834,335

(22) Filed: Aug. 24, 2015

Related U.S. Application Data
(60) Provisional application No. 62/040,955, filed on Aug. 22, 2014.

(51) Int. Cl. G07F 17/32; G07F 17/34

(52) U.S. Cl. CPC G07F 17/3213; G07F 17/34

(57) ABSTRACT

A gaming machine and method is disclosed that includes an electronic display, a player input system, a processor in communication with memory configured to store code. The code is configured to accept a wager from a player, initiate the wagering game play, define a trigger symbol, generate and display random symbols arranged in a first array of symbols, determine if a trigger symbol is present in the first array, if a trigger symbol is present in the first array, identify a location of all trigger symbols in the first array and designate the locations as mapped locations, generate a second array of symbols, designating symbols in the second array that are located at the mapped locations as predefined symbols, evaluate the second array for winning outcomes; and providing a monetary award to the player for a winning outcome.

### 1. PRIORITY CLAIM

This application claims priority to and the benefit of U.S. Provisional Patent Application No. 62/040,955 filed on Aug. 22, 2014.

### 2. FIELD OF THE INVENTION

The present invention relates to gaming machines and methods of playing and presenting games.

### 3. RELATED ART

Game players continue to seek new and exciting games. Relative to wagering games, game players enjoy games which present new and exciting ways to obtaining winning awards. One prior art method of increasing player interest in the game is to increase the number of pay lines in a slot game. By increasing the number of paylines, the players' chances of receiving a winning outcome are increased and the player is presented with additional options to consider when playing. This increases player excitement.

Another proposed feature in slot games as implemented on gaming machines is wild symbols. The wild symbol is placed on a reel, either physical or electronic, and can be assigned to a reel position. As a result, the wild symbol increases the player's perceived likelihood of receiving a winning outcome, and increases player involvement in the game when evaluating winning outcomes. However, as with increasing the number of pay lines, players have become accustomed to a wild symbol located at a fixed location on a reel.

Another known game feature is referred to a sticky wilds. However, this game features is old and known and no longer spurs player's interest. In addition, it lacks certain features present in the present gaming machine and game combination.

However, these prior art features are is now well established and known. As a result, players may not be attracted to games offering these well-known features. Therefore a new and exciting game is with new game features disclosed below.

### SUMMARY

To overcome the drawbacks of the prior art and provide additional benefits, a gaming machine, and associated game, is disclosed. In general, the disclosed gaming machine and associated slot game includes a plurality of symbols in a first array which are presented during game play on a display of a gaming machine based on execution of machine executable code. During game play, if one or more triggering symbols appear within the first array, the triggering symbol is then mapped to identify other symbol locations in the array of symbols which contain an identical or related symbol. These locations are defined as mapped locations. Thus, the location of at least one rank of non-wild symbols (such as for example, a top award symbol) will be mapped to the location of the array. That mapped location does not change even when new randomly generated symbols are generated on the display to replace the existing symbols.

In a subsequent randomization of the array (reel spin), the symbols occupying the location of the mapped symbols (symbols at mapped locations) will be replaced by an alternate symbol (preferably a wild symbol, but other modifier types are contemplated). Winning outcomes and payouts are then calculated based on the combinations formed by the modified symbols at the mapped locations and the other symbols at non-mapped locations.

It is contemplated that during game play the gaming machine may randomly identify the locations of at least one rank of non-wild symbols (i.e. without triggering symbol(s)) that will be mapped. It is also possible to have the player select which symbol is the triggering symbol. Game rules may also determine which symbol is the triggering symbol, such as amount wagered, time played, or any other factor. It is the triggering symbol that determines which symbols are the ranked symbol, and the position(s) of the same or related symbols in the array, as the ranked symbol(s), define the mapped locations.

For example, a look-up table may be resident in memory, and accessible by a processor executing machine executable code, such that certain events unrelated to the symbols that appear on the array may trigger the mapping function. This look-up table may contain random numbers where, on average, a triggering event occurs, in one example embodiment, every 50 spins. Hence, the triggering event or triggering symbol may not occur during every round of play. It is contemplated that other embodiments will have different rates of occurrence of the trigger symbol.

Another embodiment may have triggers associated with events that occur in the top box of the slot machine, a secondary game outcome, or events that occur on the periphery of the reel array. Thus, it is contemplated that the various embodiments disclosed herein are not limited to “triggering symbols” that “appear within the array.” Thus, a winning event on a secondary game serve as the trigger, or determine which symbol type is the ranked symbol type. It is also contemplated that if a trigger symbol appears in an array of symbols, then the player playing the game will activate the secondary event, and the outcome of the secondary event determines an award or a trigger symbol. Additionally, in one exemplary configuration, the rank or type of the symbol that is the triggering symbol could be randomly chosen by the computer program every time the feature occurs versus choosing the same rank (i.e. the Top Award Symbol) each time.

In one embodiment, a gaming machine is provided for game play. The gaming machine includes a coin, bill, or ticket acceptor configured to load monetary value to the gaming machine. At least one electronic display is part of the gaming machine and is configured to present game information including a wagering game to a player. At least one player input device is provided that is part of or separate from the display such that the player input device is configured to accept player input regarding the wagering game. A controller is in communication with memory and the player input device. The controller is configured to execute machine-readable code stored on a memory. The memory is in communication with the controller and the machine-readable code is executable by the controller and configured to cause the electronic display to present a wagering game including the following actions. Load monetary value from the player to the gaming machine as credits and accept input from the player via the at least one player input device to accept a wager on a wagering game or enable game play. The gaming machine is configured to define a trigger symbol in the memory and generate and display on the electronic display of the gaming machine random symbols arranged in a first array. The gaming machine is configured to determine if a trigger symbol is present in the first array, and if a trigger symbol is present in the first array then the gaming machine determines a ranked symbol selected from the symbols displayed in the first array. The ranked symbol may be not present in the first array, if so, then no wild conversion occurs. The trigger symbol may be a predefined symbol with no other purpose than being a trigger symbol. It may be randomly placed in an array or established at a fixed position on a reel or reels. The ranked symbol may be the same as the trigger symbol or different. It may be player selected or machine selected.

The gaming machine is also configured to identify all symbols in the first array which match the ranked symbol and designate the locations in the first array of identified symbols which match the ranked symbol as mapped locations. The gaming machine then establishes a second array of symbols or a group of second symbols such that the second array or group of symbols are different than the first array of symbols. Then, the gaming machine designates symbols in the second array that are located at the mapped locations as wild symbols to thereby create a third array of symbols, one or more of which may be wild. The third array is a combination of first and second array symbols. The gaming machine evaluates the third array of symbols for winning outcomes and provides a monetary award to the player for a winning outcome such that an amount of the monetary award is based on the wager amount.

In one embodiment, the winning outcomes are predetermined and based on a pay table and the third array is only formed if the first array includes a trigger symbol. The second array may be part of a second wagering game. The trigger symbols may be randomly selected by the controller operating as a random number generator.

In one configuration of the gaming machine, if a trigger symbol is not present in the first array, then evaluating the first array for winning outcomes and providing a monetary award to the player for a winning outcome if a winning outcome is present in the first array such that the amount of the monetary award based on the wager amount. The trigger symbol may be the same symbol as the ranked symbol. The trigger symbol may be selected by the player prior to game play or by the gaming machine.

In another embodiment, a gaming machine is disclosed that includes at least one electronic display configured to present a wagering game to a player and at least one player input system that is configured to accept player input. A processor is in communication with a memory and the player input device such that the processor is configured to execute machine-readable code. A memory is also part of the gaming machine and configured to store non-transitory machine-readable code, the machine-readable code executable by the processor and configured to accept a wager from a player and accept input from the player to initiate the wagering game play. The code also defines a trigger symbol and generates and displays random symbols arranged in a first array of symbols. The code determines if a trigger symbol or trigger event is present in the first array and if a trigger symbol is present in the first array, identify a location of all trigger symbols in the first array and designate the locations as mapped locations. The code on the gaming machine then generates a second array of symbols which may be overlapped to the first array. The machine readable code is configured to designate symbols in the second array that are located at the mapped locations as predefined symbols. In one embodiment, the symbols are converted to a symbol type other than wild symbols, such as a predefined symbol or one or more symbols from the first array to increase the player's chance of winning. The gaming machine evaluates the second array (with the predefined symbols) for winning outcomes and provide a monetary award to the player for a winning outcome such that an amount of the monetary award is based on the wager amount.

The trigger symbol or trigger event may consist of one of the following: a player defined trigger symbol or trigger event, a trigger symbol or trigger event randomly selected by the gaming machine, and a trigger symbol or trigger event determined by a wager amount.

It is possible that generating the first array of symbols and the second array of symbols may comprise generating one or more random numbers with a random number generator and mapping the one or more random numbers to symbols. In one embodiment, the predefined symbols consist of one of the following: wild symbols, a predetermined symbol type, and the symbol in the first symbol array at the mapped location.

It is contemplated that if a trigger symbol is not present in the first array, then the machine readable code will evaluate the first array for winning outcomes and provide a monetary award to the player for a winning outcome if a winning outcome is present in the first array. The amount of the monetary award is typically based on the wager. The trigger symbol comprises a trigger event comprising more than one symbol at a predefined location or predefined order.

Also disclosed is a method of presenting a wagering game to a player with a gaming machine, such that the gaming machine has a screen, a memory, and a processor. The memory stores a non-transitory machine executable code capable of being executed by the processor to present the wagering game with the following steps. Receiving a wager from a player of the gaming machine at the gaming machine. Defining one or more trigger symbols and generating a first set of random symbols selected from a set of symbols. Then, displaying the first set of random symbols on the screen to the player and determining if the first set of random symbols includes one or more trigger symbols. During game play, if the first set of random symbols includes one or more trigger symbols, then the game generates a second set of random symbols and replaces the symbols in the first set of symbols with the second set of random symbols, except for the trigger symbols. This results in the formation and display a third set of symbols. This method of play then evaluates the third set of symbols for a winning outcome based on a group of predefined winning outcomes and provides a monetary award to the player for a winning outcome.

The first set of random symbols may be arranged in an array. The step of defining a trigger symbol may include accepting player input which defines the trigger symbol. The trigger symbols in the third set of symbols may be replaced, in one example embodiment, with wild symbols. It is possible that if a trigger symbol is not present in the first set of random symbols, then this method will evaluate the first set of random symbols for winning outcomes and providing a monetary award to the player for a winning outcome if a winning outcome is present in the first set of random symbols.

This method may further comprise, responsive to a trigger symbol being present in the first set of random symbols, selecting a symbol in the first set of symbols as a ranked symbol and replacing the ranked symbols with a wild symbols, which are maintained as wild symbols during the generation of the second set of symbols and the replacing the symbols in the first set of symbols with the second set of random symbols. It is also contemplated that the step of selecting a symbol in the first set of symbols as a ranked symbol consists one of the following: selecting the symbol based on player input, selecting the symbol randomly, or selecting the symbol based on an amount of the wager.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is an exemplary gaming machine screen display presenting the slot game disclosed herein.

FIG. 2 is an exemplary gaming machine screen display presenting the slot game disclosed herein.

FIG. 3 is an exemplary gaming machine screen display presenting the slot game disclosed herein.

FIG. 4 is an exemplary gaming machine screen display presenting the slot game disclosed herein.

FIG. 5 is an exemplary gaming machine screen display presenting the slot game disclosed herein.

FIG. 6 is an exemplary gaming machine screen display presenting the slot game disclosed herein.

FIG. 7 is an exemplary gaming machine screen display presenting the slot game disclosed herein.

FIG. 8 is an exemplary gaming machine.

FIG. 9 is an exemplary networked gaming system configured to implement the method disclosed herein.

FIG. 10A and FIG. 10B are operational flow diagrams of an example method of operation.

### DETAILED DESCRIPTION

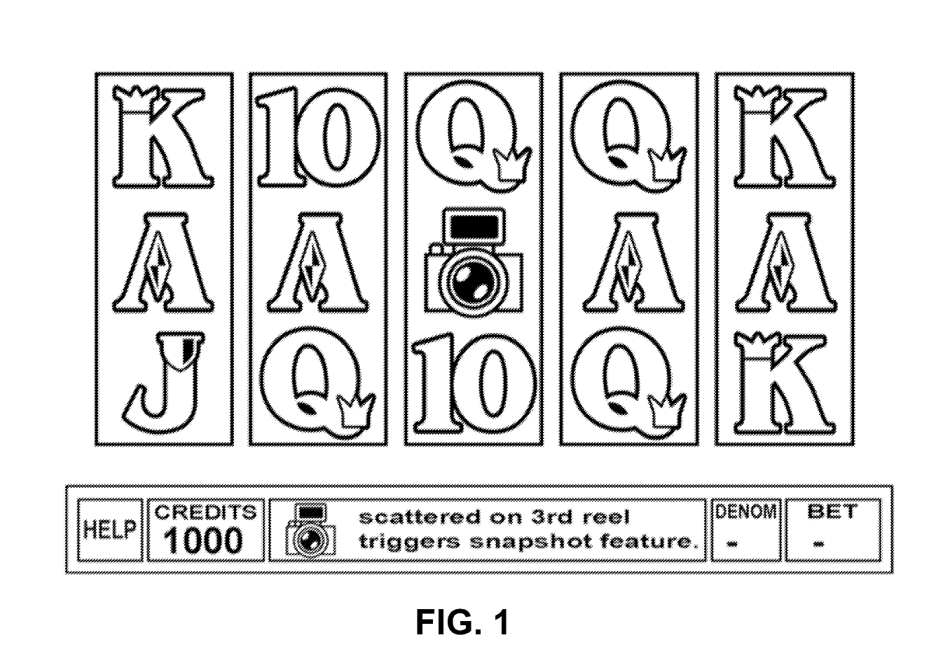

FIG. 1 is an exemplary gaming machine screen display presenting the slot game disclosed herein. This screen display may be presented to a player as part of game play on a gaming machine. The screen displays two or more reels 100, which may be physical reels or computer generated reels. On the reel, or represented as video images are symbols 104. The symbols 104 on each reel 100 are generated based on one or more random number generators during game play. Game data 108 is displayed on the screen to provide information to the player regarding game play, credits, bet amount, game play denomination, and an option for the player to obtain help or game instructions.

In one exemplary embodiment of the game, the Triggering Symbol 120 (trigger symbol) is located on the center reel 112 of a five reel array 124 (in this case, represented by a Camera Symbol). Thus, the trigger symbol may be a non-standard symbol that serves only as to trigger the conversion to wild symbols. The trigger symbol may or may not be changed to a wild symbol based on the game settings. The trigger symbol could alternatively be a standard symbol, such as the King or Queen symbol or any symbol that is part of the game play. Thus, during game play when the symbol appears, such as the Jack shown in FIG. 1, the appearance of the Jack in the array triggers the conversion of all Jacks, or a particular ranked symbol to while symbols or some other predetermined symbol. For example, the conversion as described below may convert all Jacks to Aces, which may be the highest value symbol. This display be may randomly generated during game play such that a player is presented with the screen display of FIG. 1.

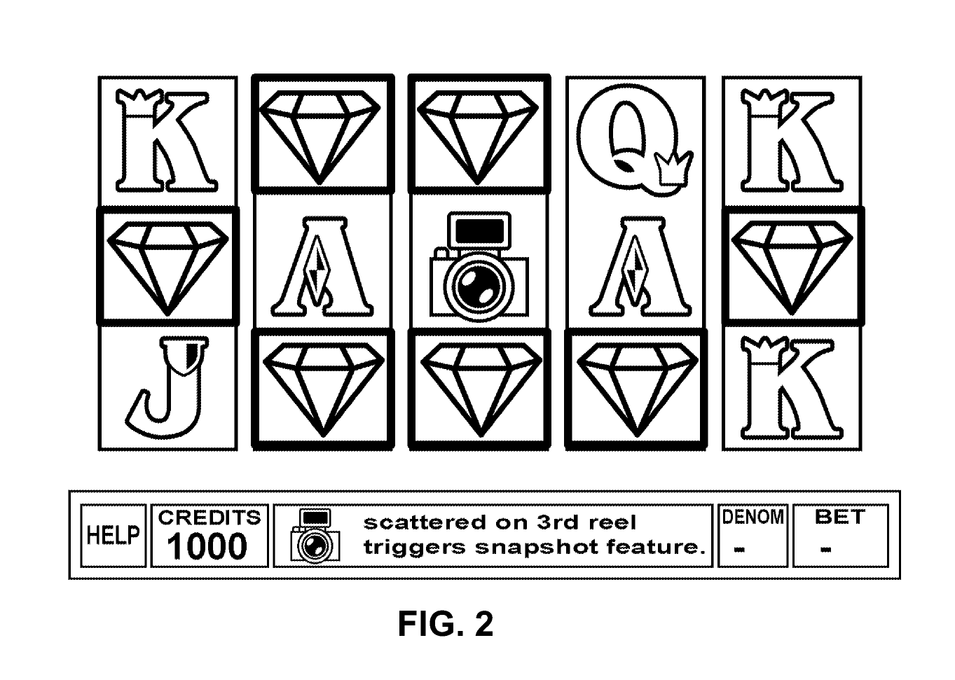

Turning now to FIG. 2, if one or more Triggering Symbols 120 appear within the array 124 during play (such as when a game is initiated, the reels spin, and then stop to display symbols), the location of at least one rank of symbols (in this embodiment a non-wild symbol) is identified by the computer program (in this case represented by a Diamond Symbol). These are defined herein as ranked symbols 130 which are identified to the player as being highlighted in a bolded, colored, or flashing box around the symbol 130 as shown. A ranked symbol may be predefined symbols or selected by the player. The ranked symbols is typically different than the trigger symbol, but could be the same.

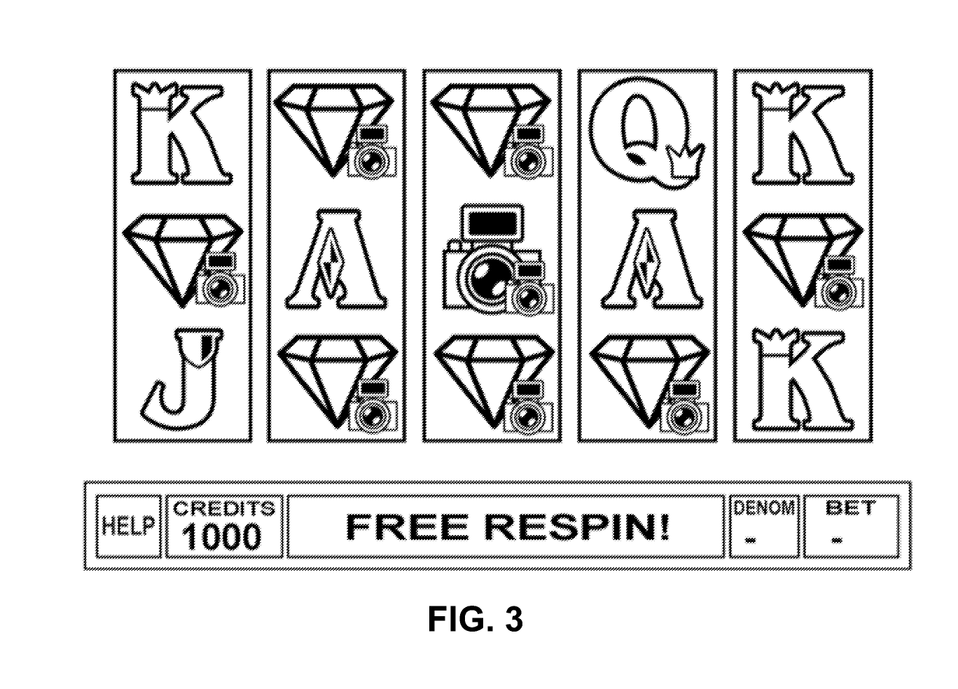

In FIG. 3, the locations of the ranked symbol(s) 130 in the array 124 are mapped or “watermarked” (or otherwise identified by some other method of indicating the location to the player). In one embodiment, the gaming machine (machine readable code) is configured to determine which displayed symbol is the ranked symbol, which in turn determines the locations of the mapped locations in the array. There may be numerous ranked symbols in the first array, just one, or none. In one embodiment the ranked symbol(s) is fixed game to game, but in another the ranked symbol(s) varies from game to game, or is selected to be a symbol shown in the first array. In another embodiment, the player determines which displayed symbol is the ranked symbol, which in turn determines the locations of the mapped locations in the array. The ranked symbols are a factor in determining winning outcomes so it is preferable to display to the player which symbols are ranked symbols.

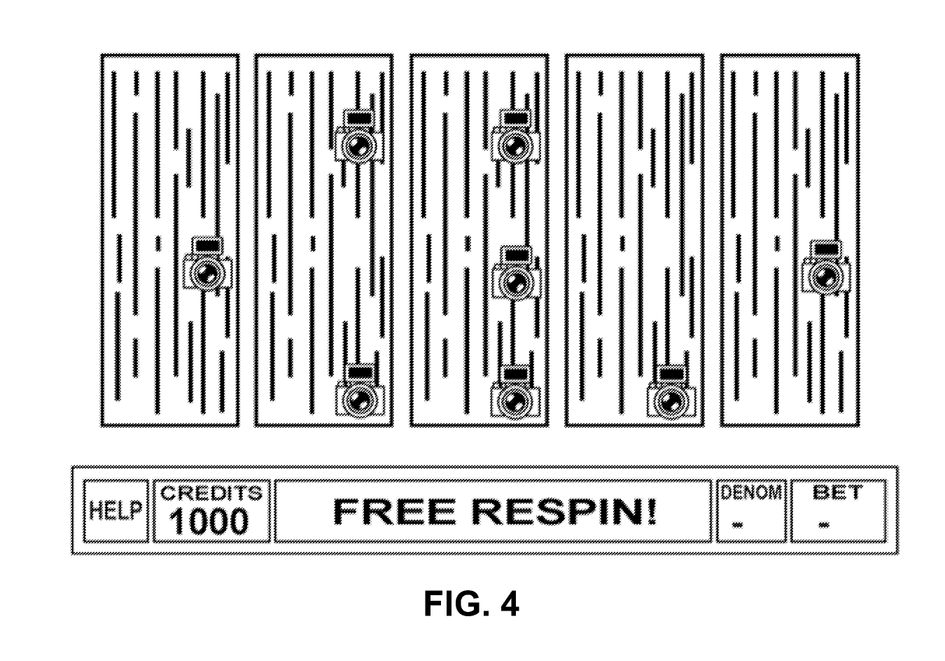

In FIG. 4, the reels are re-spun but the mapped locations 140 are still visible to the player. The mapped locations 140 are the locations in the array 124 at which the ranked symbols (element 130 in FIG. 2) are located, the position may be defined by an x and y coordinates, or by reel number and reel position. In one embodiment, winning combinations are determined at the end of the game while in other embodiments, winning combinations that appear on the reels in FIG. 3 could be evaluated to determine if a winning outcome has occurred (and paid) prior to or after the re-spin. The winning combination could be based on the base set of symbols without wild symbols, based on the symbol combination including the wild symbols, based on the ranked symbols, or based on a combination of any such symbols.

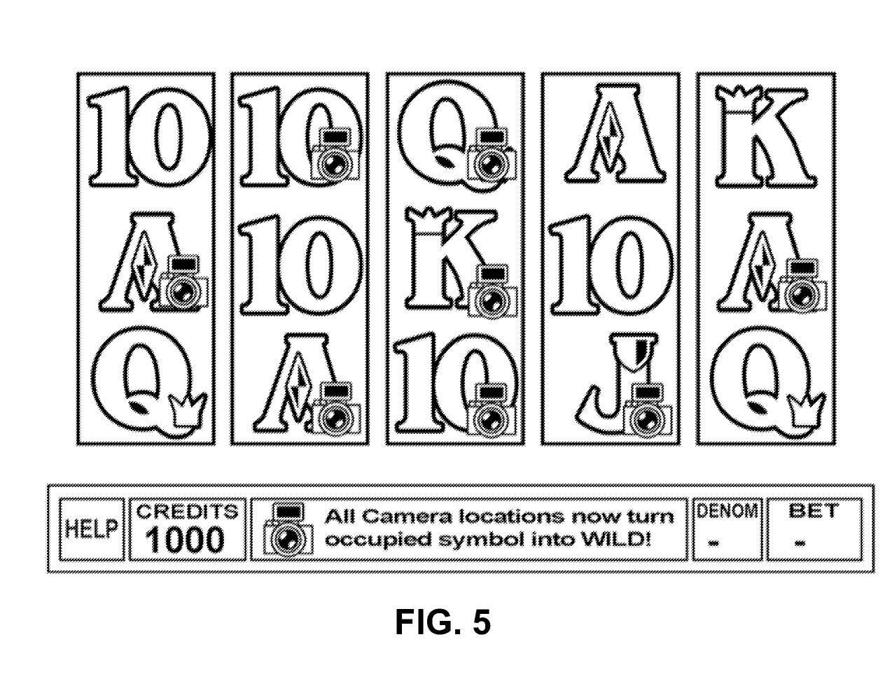

As shown in FIG. 5, the reels 100 have stopped and new symbols 136 now appear on the display of the gaming machine. These new symbols are randomly generated. The mapped locations 140 (which are the symbols that have a camera icon 142 superimposed on the symbol) are at the same location, but with newly generated symbols at the mapped locations 140. As can be seen, the player is still able to view which positions are the mapped locations 140. Game information may be provided in the game information section 108 of the display.

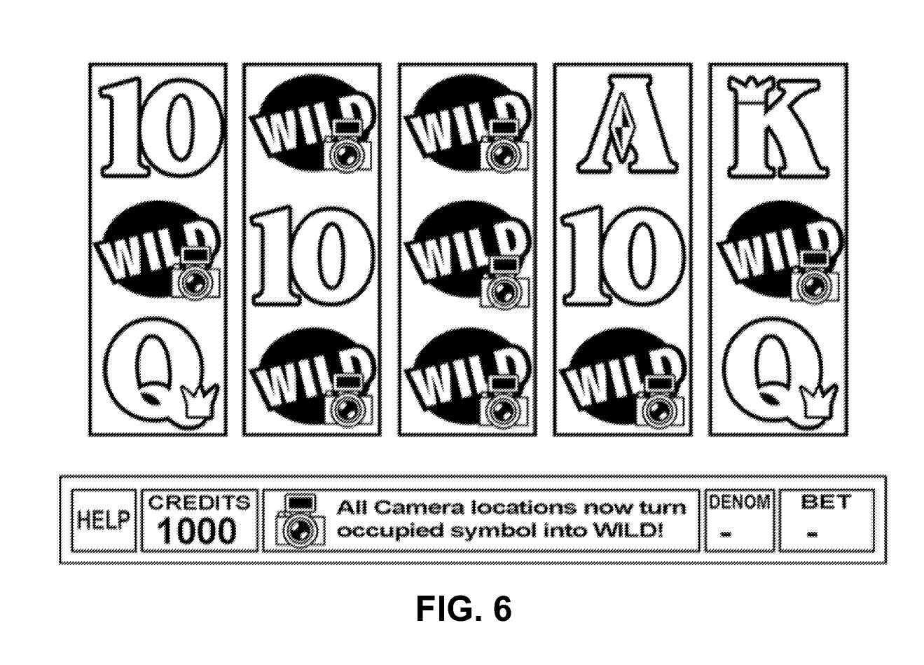

In FIG. 6, the exemplary screen display shows the symbols located behind the mapped locations 140 are changed, due to the re-spinning of the reels, to Wild Symbols 144. A designation may be made to the player that these symbols, at the mapped locations, are now wild, such as by using the term wild over the symbol area. However, in other embodiments other ways of designating a wild symbol may be used. It is also contemplated that other modifiers can be applied to the symbols instead of making the symbols at the mapped location be wild symbols. For example, the modification applied to the symbol at the mapped location may be included but is not limited to a 2× multipliers (or any ratio), a bonus trigger symbols to enter into a bonus round, or a symbol that is the same as another symbol in the array.

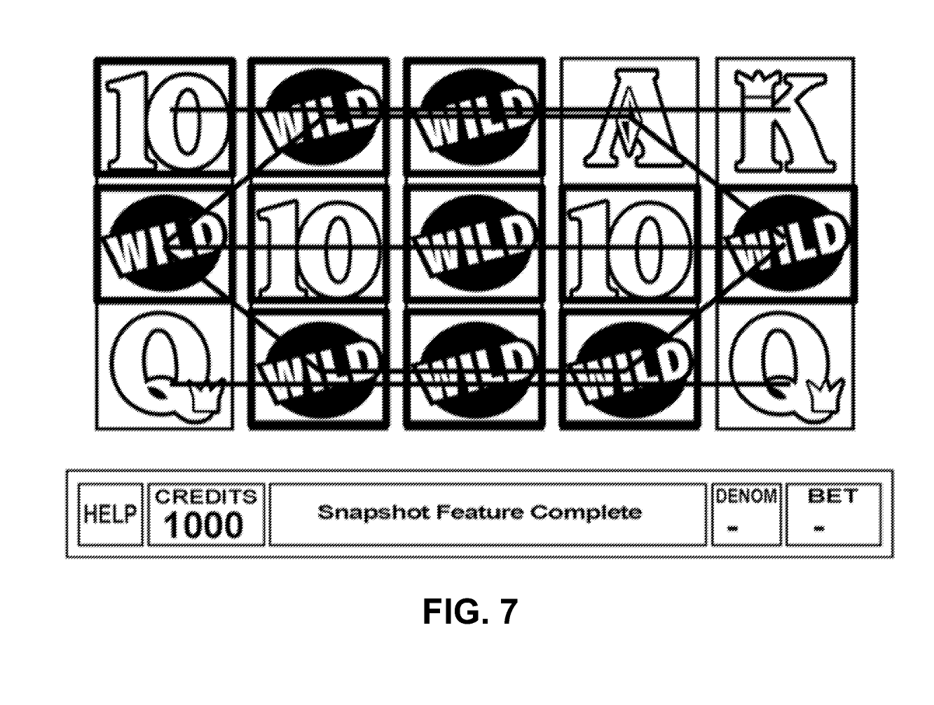

FIG. 7 illustrates an exemplary screen shot with paylines showing winning outcomes. As can be seen in this figure, a greater number of winning outcomes are possible due to the wild symbols being present. The lines (selectively labeled element 180) designate winning outcomes that are possible and which may result in payouts subject to the amount of the wager by a player. As is understood, larger wagers can enable a greater number of paylines, and active paylines may now result in a payment due to the conversion of standard symbols to wild symbols at the mapped locations. Thereafter, winning outcomes are evaluated and the player is paid according to a paytable associated with the game. The paytable payout amount, and which slot symbol outcomes are winning outcomes are determined by the paytable and may vary based upon wager amount, the game, and which symbol groups are winning outcomes.

The gaming machine may be located at a casino (and as such is referred to as a “casino gaming machine”). The gaming machine may be part of a gaming system, such as a casino gaming system which links multiple gaming machines, one or more table games and other devices such as kiosks, accounting systems or servers, progressive systems or servers, player tracking systems or servers or the like.

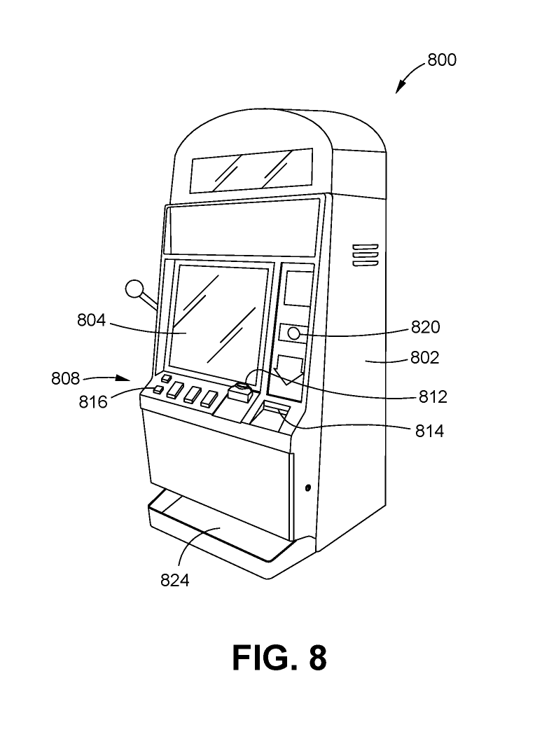

One configuration of a gaming machine 800 is illustrated in FIG. 8. As illustrated, the gaming machine 800 generally comprises a housing or cabinet 802 for supporting and/or enclosing various components required for operation of the gaming machine. In the embodiment illustrated, the housing 802 includes a door located at a front thereof, the door capable of being moved between an open position which allows access to the interior, and a closed position in which access to the interior is generally prevented. The configuration of the gaming machine 800 may vary. In the embodiment illustrated, the gaming machine 800 has an “upright” configuration. However, the gaming machine 800 could have other configurations, shapes or dimensions (such as being of a “slant”-type, “bar-top” or other configuration as is well known to those of skill in the art).

The gaming machine 800 preferably includes at least one display device 804 configured to display game information. The display device 804 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 804 may be capable of projecting or displaying a wide variety of information, including images, symbols and other indicia or information associated with game play, game promotion or other events.

As described in more detail below, the gaming machine 800 is preferably configured to present one or more games upon a player making a monetary payment or wager. In this regard, as described in more detail below, the gaming machine 800 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 800 includes means for returning unused monetary funds and/or dispensing winnings to a player.

The gaming machine 800 preferably includes one or more player input devices 808 (such as input buttons, plunger mechanisms, a touch-screen display, joystick, touch-pad or the like). These one or more devices may be utilized by the player to facilitate game play, such as by providing input or instruction to the gaming machine 800. For example, such input devices 808 may be utilized by a player to place a wager or a side wager, cause the gaming machine 800 to initiate a game, to indicate cards to be held or discarded, to “cash out” of the gaming machine, or to provide various other inputs. The game and gaming machine disclosed herein may be optionally equipped with a side wager.

In one preferred embodiment, the gaming machine 800 includes at least one microprocessor or controller for controlling the gaming machine, including receiving player input and sending output signals for controlling the various components of the machine 800 (such as generating game information for display by the display 804). The controller may be arranged to receive information regarding funds provided by a player to the gaming machine, receive input such as a purchase/bet signal when a purchase/bet button 816 is depressed, and receive other inputs from a player. The controller may be arranged to generate information regarding a game, such as generating game information for display by the at least one display 804 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 800 may also include one or more random number generators for generating random numbers, such as for use in selecting cards and for presenting the game in a random fashion.

Preferably, the controller, such as a processor, is configured to execute machine readable code or instructions which are configured to implement the method of game play of the invention. For example, the controller ofthe gaming machine 800 may be configured to detect a wager, such as a signal from a player's depressing of the “bet one” button. Upon such an event and/or the player otherwise signaling the gaming machine to present the game, the controller may be configured to cause cards to be dealt/displayed on the at least one display 804. The controller may accept input from a player of a request to split, buy insurance, obtain additional cards, activate slot reels, or the like via the one or more player input devices 808 of the gaming machine 800.

The gaming machine 800 may be configured to generate and present games in a stand-alone manner or it may be in communication with one or more external devices at one or more times. For example, the gaming machine 800 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 800 is configured to present one or more wagering games. Thus, the gaming machines 800 is preferably configured to accept value, such as in the form of coins, tokens, paper currency or other elements or devices representing value such as monetary funds. For example, as illustrated in FIG. 8, the gaming machine 800 might include a coin acceptor 812 for accepting coins. Of course, associated coin reading/verifying devices and coin storage devices may be associated with the gaming machine 800 if it is configured to accept coins. Likewise, the gaming machine 800 might include a media reader 814. Such a reader may be configured to accept and read/verify paper currency and/or other media such as tickets. Of course, in such event the gaming machine 800 may further be configured with one or more paper currency or ticket storage devices, such as cash boxes, and other paper currency or media handling devices (including transport devices).

The gaming machine 800 might also be configured to read FOBs, magnetic stripe cards or other media having data associated therewith and via which value or funds may be associated with the gaming machine 800.

In one embodiment, the gaming machine 800 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 800 dispensing coins to a coin tray 824. In another embodiment, funds may be issued by dispensing paper currency. In yet another embodiment, a player may be issued a media, such as a printed ticket, which ticket represents the value which was paid or cashed out of the machine.

The gaming machine 800 may also include a player tracking device, such as a card reader and associated keypad 820. Such player tracking devices are well known and may permit the game operator to track play of players of the gaming machine. The tracked play may be utilized to offer player bonuses or awards.

It will be appreciated that the gaming machine illustrated in FIG. 8 is only exemplary of one embodiment of a gaming machine. For example, it is possible for the gaming machine to have various other configurations, including different shapes and styles and having different components than as just described.

For example, it is possible for the base game to be presented on a computing device, including at a home or office computer, a kiosk or other types of devices. For example, the game might be presented via an application running on a computing device, or in a server-based or “Internet” environment. In one embodiment, a player might log in to a casino server and the controller of the casino server may cause game information to be delivered to the player's computer and then be displayed on a display of the player's computer. In this regard, it will be noted that the term “controller” may comprise more than one device. For example, in a server-based environment, a controller at a server may generate game information and transmit that information to a local controller at a gaming machine. The local controller at the gaming machine may then cause game information to be displayed on the display of the gaming machine. The games of the invention could also be presented by or at hand-held devices, such as PDAs, cellular phones, tablet computing devices or the like.

A casino may have numerous gaming machines 800, possibly located on a casino floor or in other locations. Of course, such gaming machines 800 might be used in other environments, such as an airport, a bar or tavern or other locations.

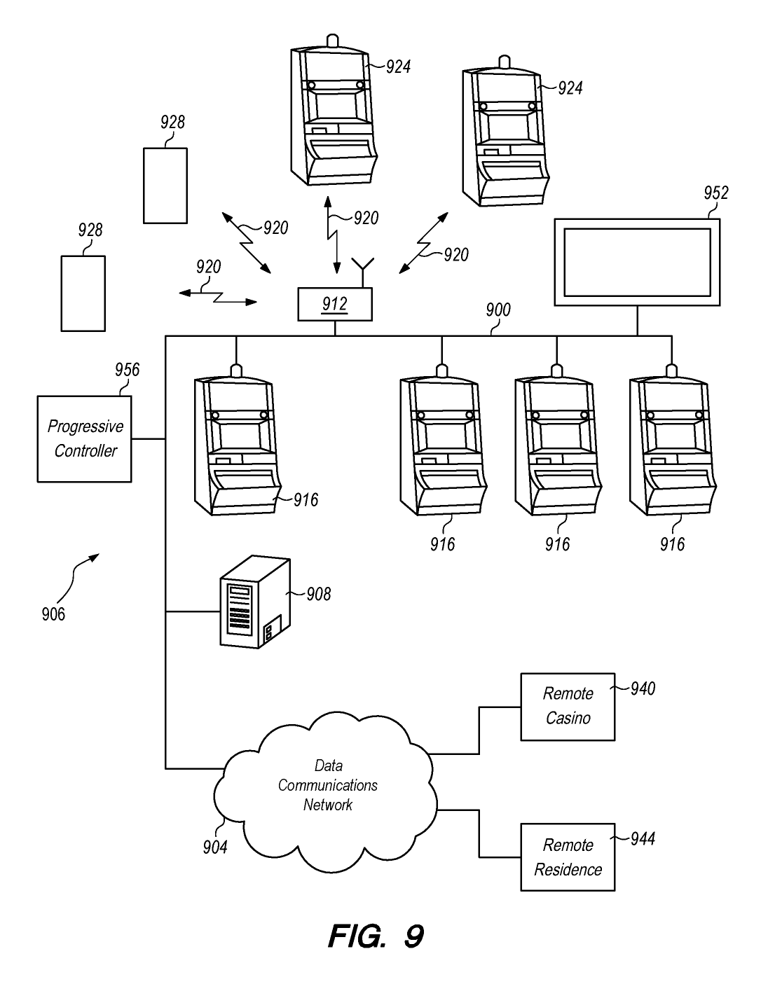

FIG. 9 is a block diagram of an example gaming system with a server based network. The communications network 900, 904 connects to multiple devices as discussed below to enable communication between devices. The network 900, 904 may be any type network capable of exchanging data between devices. The network may include a local network 900 and an external network 904 such as for example the Internet, or an Intranet with appropriate security mechanisms. The wagering game network may include other network devices, such as one or more servers which may comprise accounting servers, wide area progressive servers, player tracking servers, game content servers, or any other type server.

In this embodiment the gaming establishment at the top of the figure includes a network 900. As shown, the gaming network includes gaming machines 916 connected to the network 900 via a wired connection.

The network 900 may include a wireless device 912 capable of communicating over a wireless link 920 with one or more wireless gaming machines 924 or hand held gaming devices 928 A wagering game server 908 may serve wagering games on the gaming machines over the local area network 900 and function as a remote controller for the wagering games as described above.

The wagering network includes hardware and memory storing machine readable instructions and machine readable code for performing the operations described herein. Those of ordinary skill in the art will appreciate that each gaming establishment may include additional local area networks such which may serve to connect many other wagering games. Alternatively, multiple servers 908 may be used for the functions of the wagering game server which provide game content to the gaming machines 916, 924, 928.

The local area network 906 may be any type of suitable property LAN configuration including, for example, a dedicated hardwired property LAN or a wireless property LAN. The local area network 906 may be configured in any configuration or topology.

The local area network 906 includes wired communication links 900 and wireless communication links 920. In this example configuration, the stand-alone gaming machines 916 communicate with the network 902, 908 via the wired communication links as shown. The stand-alone gaming machines 928 as well as the handheld gaming devices 928 communicate with the network 900, 908 via the wireless communication links 920. One or more wireless communication devices 912, with associated antennas, enables wireless communication. Other combinations of wired and wireless connections to different gaming machines may be used. The wired and wireless communication links may employ any suitable connection protocols such as Bluetooth, IEEE 802.11, Ethernet, or any other format or standard. The network 900, 908 may be configured to enable downloading of instruction sets (software) for games, game configuration data, game outcomes, from the central server(s) such as the server 908 to the gaming machines, and to enable uploading or downloading of marketing and operations data from the gaming terminals to the central server.

As shown at the bottom of FIG. 9, the game server 908 or network 900 may also serve wagering game devices and/or distribute content to devices located in other gaming establishment 940 or at other locations 944 such as a residence.

The server 908 may be any type computer capable of executing programs or instruction sets for controlling gaming machine, such as slot machines, video slots, or video poker machines, and communication with wireless devices. Although shown as a single server, numerous servers may be used. In such embodiments, the gaming machines 916, 924, 928 may each be a simple input/output terminal with regard to the functions controlled by the server 908. For example, the random selection of outcomes for the basic game and any bonus game may be functions performed by the server 908 and subsequently provided to a gaming machine. Functions that are not provided by the server 908, such as control of the local lights, sounds, and displays of the gaming machine, are handled by the local CPU within the gaming machine.

In this embodiment, a progressive or accumulated jackpot system is provided that includes a video or other type display 952 that is coupled to the network 900, 908. The display 952 is viewable by a number of players to present a total jackpot that is available for award upon receipt of a predetermined outcome. This type event may be referred to as community based events accessible from games on the gaming machines or from remote locations 940, 944 or gaming devices 928. For example, the display 952 may be used to show a current progressive jackpot or jackpots which players playing different gaming machines may be eligible to win. The display 952 may be any type display.

In one embodiment, the community event is a progressive award or jackpot, which is preferably linked with other gaming machines via the network 900, 908 and/or the network 204. The entire progressive award or jackpot may be won upon the occurrence of a certain outcome of the game.

The server 908 may also operate one or more progressive awards concurrently with the basic game and/or bonus games. As explained above, such progressive awards are funded by appropriating a percentage of the coin-in from participating gaming machines. To be eligible to win the progressive award, the player may be required to make a progressive award side wager or make a wager satisfying predetermined criteria, e.g., a maximum wager or a wager covering all available paylines in the basic game. Then, upon occurrence of jackpot-won event in the form of either a “mystery” event or one or more predetermined outcomes in the basic game and/or bonus game, the player is awarded the progressive jackpot in addition to any regular prize or award resulting from the basic game and/or bonus game. The jackpot-won event may, for example, be the appearance of a predetermined scatter symbol during the basic game. A basic game menu may be part of the game disclosed herein and include several options for a player, including picking games, progressive options, and side bet options. Other community events may include a community bonus game, a bonus prize shared by multiple players, a multiplier award or other community features. Such a community event may interrupt the game play on the gaming machine 10 and use other mechanisms such as the display 952 to show graphics or video relating to the community event. In this example embodiment, each one of the players who are currently playing wagering games on the gaming machines participates in the community event according to an eligibility criteria such as time-based eligibility that each gaming machine determines locally. In this example, a community event or progressive controller 956 associated with the display 952 and progressive system continuously runs a process to determine if the community bonus should occur, using its random number generator (RNG) and monitor coin-in or wagers to increment the amount on the display. For example, controller 956 determines if the community event is triggered. If the controller 965 determines that the community event is triggered or won, then it will issue an invitation to the gaming machines. Because each of the wagering games on the gaming machines keeps track of the current eligibility of the respective games being played, each of the gaming machines makes a decision whether it will allow the player to participate in the community event, and at which multiplier any bonuses or prizes resulting from the community event will be awarded to the player. It is to be understood that a server such as the server 908 or a master gaming machine may be used for the controller 956.

The server 908 includes a storage device that contains software instruction sets for different wagering games which may be loaded onto a memory of gaming machines. It is to be understood that different parts of the instruction sets may be stored on the memory with other parts of the instruction sets stored on the individual gaming machines. For example, the gaming machines may store part of the instruction sets in the form of modules relating to graphics files, audio/sound files, and certain game functions and operations such as player greetings or instructions. The stored instructions sets are mated with the remainder of the instruction sets loaded from the memory over the network 900.

Part or all of the software instruction set for wagering games may be sent to the various gaming machines via the wired communication links 900 or the wireless communication links 920. The wagering games may be stand alone or may offer eligibility or access to progressive awards or support other community events with other gaming machines on the network 900 or external networks 904.

The server 908 in this example stores a number of wagering games in the storage device. It is to be understood that part of the software to support the wagering games may already reside on the system memory of the gaming machine. For example, the modules responsible for RNG, audio and/or video drivers, etc. may reside on the system memory of the gaming machine. Other components of the instruction set of the game such as graphics files, audio files etc. may also reside in the storage device. Some or all of the instruction set may be loaded via the external I/O circuit from the network 900 such as from the storage device of the server 908. In this manner, the gaming machine may be used to play different games without requiring manual delivery of instruction sets different games to the gaming machine.

For example, a player may request a certain wagering game based on an initial display of a menu of wagering games displayed by the gaming machine. The menu may include some or all available wagering games stored on the server 908. Other background graphics and/or videos may be displayed on the primary display or the secondary display of the gaming machine to attract players to the gaming machine. The secondary display may be electronic or a secondary game to present a secondary game outcome. Based on the menu display 400, a player may select the desired game via a player input device such as the push buttons 26 or touch screen buttons 30. Further, an operator of the casino 202 may use the server 214 to load wagering games to different gaming machines based on popularity, location, time interval, special events, schedule, etc.

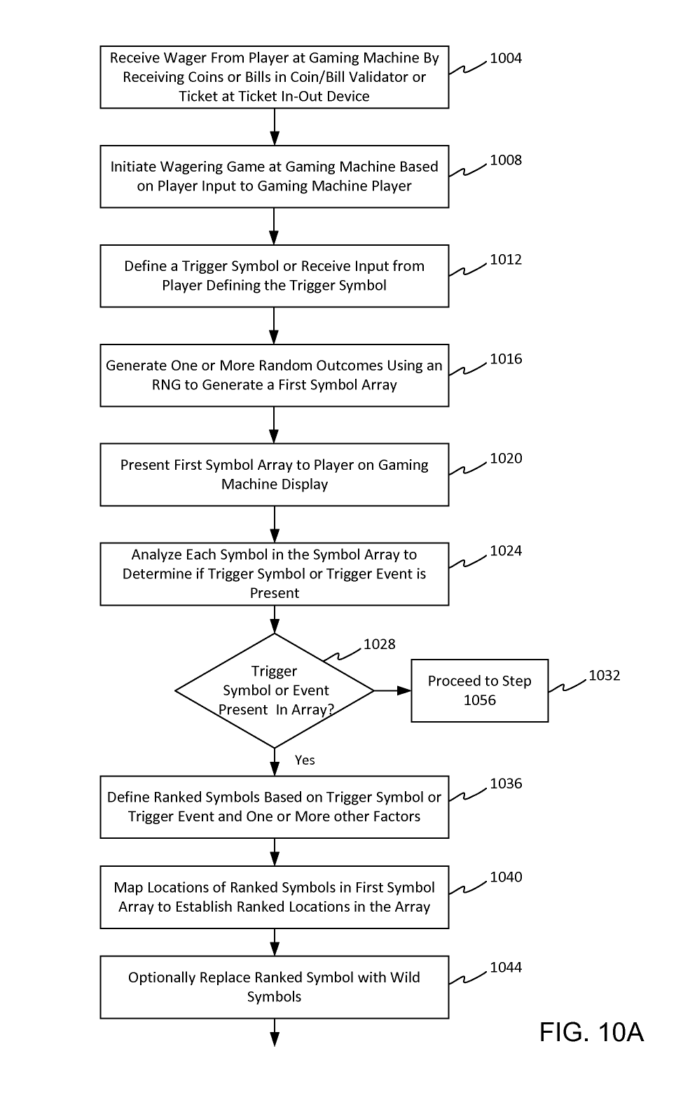

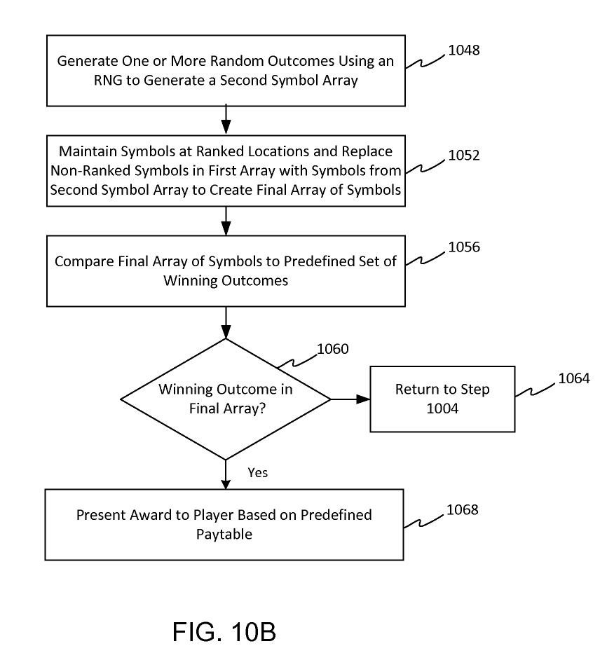

FIGS. 10A and 10B provide an exemplary flow diagram of an example method of operation. This is but one possible method of operation and other methods of play are possible. In this embodiment, at a step 1004 the gaming machine receives a wager from a player at the gaming machine by receiving coins or bills at a bill or coin validator or by receiving and scanning a ticket with a ticket in-out device. At a step 1008, the wagering game is initiated by the player based on player input to the gaming machine. This step may be combined with step 1004.

At a step 1012, the gaming machine or the user defined a trigger symbol or trigger event. The terms trigger system and trigger event are defined above. Then, at a step 916, the gaming machine generates one or more random outcomes using a random number generator (RNG) to generate a first symbol array. Each or one or more of the symbols in the array are randomly selected from a predetermined set of symbols to form an array of symbols.

Then, at a step 1020 the gaming machine presents the first symbol array to the player on the display or other presentation device of the gaming machine. As part of this display of the first array, winning outcomes in the first array may optionally be determined and the player paid based on a paytable corresponding to first array outcome. At a step 1020 game play resumes and the gaming machine processor executing code analyzes each symbol in the symbol array presented to the player to determine if the trigger symbol or trigger event is present or occurred. The trigger symbol may be a predefined symbol that is not part of standard play, such as the camera 120 in FIG. 1, or the trigger symbol could be a standard symbol, such as the King symbol shone in FIG. 1. Alternatively, the trigger event may be predefined outcome, such as three 10 symbols or a string of cherry symbols (not shown) in a particular pattern in the first array. At a decision step 1028, the method of play determines if the trigger symbol or trigger event is present. If not, the operation advances to a step 1032, which causes the operation to advance to a step 1056, which is discussed below in detail.

Alternatively, if at decision step 1028 the trigger symbol or trigger event are present in the first symbol array, then the operation advances to step 1036. At a step 1036, the gaming machine defines ranked symbols based on the trigger symbols or trigger event or events. Then at a step 1040, the gaming machine maps the ranked symbols in the first symbol array to establish ranked locations in the array. The ranked locations are locations in the array where the ranked symbols are located.

At a step 1044 the method of play may optionally replace ranked symbols with wild symbols, such that the ranked symbols or the ranked locations are replaced with wild symbols. At a step 1048 the gaming machine generates one or more random outcomes using an RNG to generate a second symbol array. Then, at step 1052, the gaming machine maintains symbols at the ranked locations (which are the trigger symbols or the wild symbols from the earlier step), but replaces the other symbols with new symbols of the second symbol array at step 1048. This creates a final array of symbols, which may also be considered a third array of symbols based on the first array and the second array.

At a step 1056 the gaming machine compares the final array of symbols to a predefined set of winning outcomes. This may occur on a payline by payline basis based on the wager amount, such that additional wager amount results in a higher number of paylines being active. If at decision step 1060 the gaming machine determines there is not a winning outcome on an active payline, then the operation advances to step 1064 and the method may end, or return to step 1004.

Alternatively, if at step 1060 the gaming machine determines that a winning outcome is present in the final array, then the method of play advances to step 1068 and an award is presented to the player based on a predefined paytable. The predefined paytable may vary based on the wager amount.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A gaming machine comprising:
a coin, bill, or ticket acceptor configured to load monetary value to the gaming machine;
at least one electronic display configured to present game information including a wagering game to a player;
at least one player input device that is part of or separate from the display, the player input device configured to accept player input regarding the wagering game;
a controller in communication with memory and the player input device, the controller configured to execute machine-readable code;
memory in communication with the controller, the memory configured to store machine-readable code, the machine-readable code executable by the controller and configured to cause the at least one electronic display to present a wagering game including the following:
load monetary value from the player to the gaming machine as credits;
accept input from the player via the at least one player input device to accept a wager on a wagering game or enable game play;
define a trigger symbol in the memory;
generate and display on the electronic display of the gaming machine random symbols arranged in a first array;
determine if a trigger symbol is present in the first array;
if a trigger symbol is present in the first array, identify a ranked symbol;
identify all symbols in the first array which match the ranked symbol and designate the locations in the first array of identified symbols which match the ranked symbol as mapped locations;
establish a second array of symbols, the second array of symbols different than the first array of symbols;
designate symbols in the second array that are located at the mapped locations as wild symbols to thereby create a third array of symbols, one or more of which may be wild;
evaluate the third array of symbols for winning outcomes; and
provide a monetary award to the player for a winning outcome, an amount of the monetary award based on the wager amount.

2. The gaming machine of claim 1, wherein the winning outcomes are predetermined based on a pay table and the third array is only formed if the first array includes a trigger symbol.

3. The gaming machine of claim 1 wherein the second array is part of a second wagering game.

4. The gaming machine of claim 1 wherein trigger symbols are randomly selected by the controller operating as a random number generator.

5. The gaming machine of claim 1 wherein if a trigger symbol is not present in the first array, then evaluating the first array for winning outcomes and providing a monetary award to the player for a winning outcome if a winning outcome is present in the first array, the amount of the monetary award based on the wager amount.

6. The gaming machine of claim 1 wherein the trigger symbol is the same symbol as the ranked symbol.

7. The gaming machine of claim 1 wherein the trigger symbol is selected by the player prior to game play.

8. A gaming machine comprising:
at least one electronic display configured to present a wagering game to a player;
at least one player input system, the player input system configured to accept player input;
a processor in communication with memory and the player input device, the processor configured to execute machine-readable code;
memory configured to store non-transitory machine-readable code, the machine-readable code executable by the processor and configured to:
accept a wager from a player;
accept input from the player to initiate the wagering game play;
define a trigger symbol;
generate and display random symbols arranged in a first array of symbols;
determine if a trigger symbol is present in the first array;
if a trigger symbol is present in the first array, identify a location of all trigger symbols in the first array and designate the locations as mapped locations;
generate a second array of symbols;
changing symbols in the second array that are located at the mapped locations as predefined symbols;
evaluating the second array for winning outcomes; and
providing a monetary award to the player for a winning outcome, an amount of the monetary award based on the wager.

9. The gaming machine of claim 8, wherein the trigger symbol or trigger event consists of one of the following: a player defined trigger symbol or trigger event, a trigger symbol or trigger event randomly selected by the gaming machine, or a trigger symbol or trigger event determined by a wager amount.

10. The gaming machine of claim 8, wherein generating the first array of symbols and the second array of symbols comprises generating one or more random numbers with a random number generator and mapping the one or more random numbers to symbols.

11. The gaming machine of claim 8, wherein the predefined symbols consist of one of the following: wild symbols, a predetermined symbol type, the symbol in the first symbol array at the mapped location.

12. The gaming machine of claim 8, wherein if a trigger symbol is not present in the first array, then evaluating the first array for winning outcomes and providing a monetary award to the player for a winning outcome if a winning outcome is present in the first array, the amount of the monetary award based on the wager.

13. The gaming machine of claim 8 wherein the trigger symbol comprises a trigger event comprising more than one symbol at a predefined location or predefined order.

14. A method of presenting a wagering game to a player with a gaming machine, the method comprising:
providing a gaming machine having a screen, a memory, and a processor, the memory storing non-transitory machine executable code capable of being executed by the processor to present the wagering game;
receiving a wager with a gaming machine, the wager from a player;
defining one or more trigger symbols;
generating a first set of random symbols selected from a set of symbols;
displaying the first set of random symbols on the screen to the player;
determining if the first set of random symbols includes one or more trigger symbols;
if the first set of random symbols includes one or more trigger symbols, generating a second set of random symbols and replacing the symbols in the first set of symbols with the second set of random symbols except for the trigger symbols to thereby form and display a third set of symbols;
evaluating the third set of symbols for a winning outcomes based on a group of predefined winning outcomes; and
providing a monetary award to the player for a winning outcome.

15. The method of presenting a wagering game of claim 14 wherein the first set of random symbols are arranged in an array.

16. The method of presenting a wagering game of claim 14 wherein defining a trigger symbol comprises accepting player input which defines the trigger symbol.

17. The method of presenting a wagering game of claim 14 wherein the trigger symbols in the third set of symbols are replaced with wild symbols.

18. The method of presenting a wagering game of claim 14 wherein if a trigger symbol is not present in the first set of random symbols, then evaluating the first set of random symbols for winning outcomes and providing a monetary award to the player for a winning outcome if a winning outcome is present in the first set of random symbols.

19. The method of presenting a wagering game of claim 14 further comprising, responsive to a trigger symbol being present in the first set of random symbols, selecting a symbol in the first set of symbols as a ranked symbol and replacing the ranked symbols with a wild symbols, which are maintained as wild symbols during the generation of the second set of symbols and the replacing the symbols in the first set of symbols with the second set of random symbols.

20. The method of presenting a wagering game of claim 19 wherein selecting a symbol in the first set of symbols as a ranked symbol consists one of the following: selecting the symbol based on player input, selecting the symbol randomly, selecting the symbol based on an amount of the wager.
